(19) United States
(12) Patent Application Publication
(10) Pub. No.: US 2013/0116379 A1
(43) Pub. Date: May 9, 2013

(54) BINDER COMBINATIONS FOR STRUCTURAL DRINKING WATER PIPE COATINGS

(71) Applicant: Christian Wamprecht, Neuss (DE)

(72) Inventor: Christian Wamprecht, Neuss (DE)

(73) Assignee: Bayer Intellectual Property GmbH, Monheim (DE)

(21) Appl. No.: 13/810,707

(22) PCT Filed: Jul. 15, 2011
(86) PCT No.: PCT/EP11/62183

§ 371 Date: Jan. 17, 2013

(30) Foreign Application Priority Data
Jul. 20, 2010 (DE) 10 2010 031 682.2

(51) Int. Cl. C09D 175/08

(52) U.S. Cl. CPC C09D 175/08
USPC 524/590

(57) ABSTRACT

The present invention relates to coating systems for the production of quick-drying structural coatings based on (cyclo)aliphatic, filler-containing prepolymers and (cyclo)aliphatic polyisocyanates as well as amino-functional polyaspartic acid esters as curing agents.

The present invention relates to coating systems for the production of quick-drying structural coatings based on specific (cyclo)aliphatic prepolymers and (cyclo)aliphatic polyisocyanates as well as amino-functional polyaspartic acid esters as curing agents.

Two-component coating systems based on polyurethane or polyurea are known and are already in use in the art. They generally contain a liquid polyisocyanate component and a liquid isocyanate-reactive component. The reaction of polyisocyanates with amines as the isocyanate-reactive component yields highly crosslinked polyurea coatings. However, primary amines and isocyanates in most cases react very quickly with one another. Typical pot lives or gel times are often only from several seconds to a few minutes. Such polyurea coatings can therefore not be applied manually, but only using special spray devices. However, such coatings possess excellent physical and mechanical properties.

A method known from the literature for reducing this high reactivity is the use of prepolymers having a low NCO content. By using NCO-functional prepolymers in combination with amines it is possible to produce flexible polyurea coatings.

U.S. Pat. No. 3,428,610 and U.S. Pat. No. 4,463,126 disclose the production of polyurethane/polyurea elastomers by curing NCO-functional prepolymers with aromatic diamines. These are preferably di-primary aromatic diamines, which have at least one alkyl substituent having from 2 to 3 carbon atoms in the ortho-position relative to each amino group and optionally in addition methyl substituents in further ortho-positions relative to the amino groups, such as, for example, diethyltoluyldiamine (DETDA).

U.S. Pat. No. 3,428,610 and U.S. Pat. No. 4,463,126 describe a process for the production of solvent-free resilient coatings, in which NCO prepolymers based on isophorone diisocyanate (IPDI) and polyether polyols are cured at room temperature with sterically hindered di-primary aromatic diamines.

A disadvantage of such systems is that the aromatic diamines have a tendency to pronounced yellowing.

A further possibility of slowing down the reaction between polyisocyanates and amines is the use of secondary amines. EP-A 0 403 921, U.S. Pat. No. 5,126,170 and WO 2007/039133 disclose the formation of polyurea coatings by reaction of polyaspartic acid esters with polyisocyanates. Polyaspartic acid esters possess a low viscosity and reduced reactivity towards polyisocyanates and can therefore be used for the production of solvent-free coating compositions with extended pot lives. An additional advantage of polyaspartic acid esters is that the products are colourless.

Colourless, aliphatic polyisocyanate prepolymers based on polyether polyols, on the other hand, cure slowly with polyaspartic acid esters, and the coatings often have a tacky surface. Although polyisocyanate prepolymers according to WO 2007/039133 cure more quickly with polyaspartic acid esters, acceptable mechanical properties are often only achieved after several hours to several days. The tensile strength of the coatings in particular is in need of improvement.

The object underlying the present invention was, therefore, to provide two-component coating compositions for the production of polyurea coatings which have sufficiently long pot lives to permit also manual two-component application and with which quick-drying, clear and as light-coloured as possible structural coatings having good application-related data, such as resilience, hardness and tensile strength, can be produced.

That object has been achieved by the combination of specific allophanate polyisocyanates with polyaspartic acid esters.

The invention accordingly provides two-component coating systems at least comprising
A) a polyisocyanate component consisting of
   a. (cyclo)aliphatic isocyanate prepolymers based on (cyclo)aliphatic polyisocyanates and at least one filler-containing polyether based on styrene-acrylonitrile copolymers and/or polyureas,
   b. (cyclo)aliphatic polyisocyanates,
B) amino-functional polyaspartic acid esters of the general formula (I)

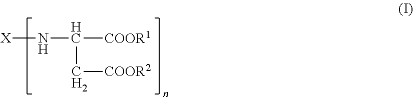

in which
X represents an n-valent organic radical, which is (formally) obtained by removing the primary amino groups of an n-valent polyamine,
R¹, R² represent identical or different organic radicals which are inert towards isocyanate groups under the reaction conditions, and
n represents an integer of at least 2.

The (cyclo)aliphatic prepolymers used in component A) are obtainable, for example, by reacting

a1) one or more (cyclo)aliphatic polyisocyanates with
a2) one or more polyhydroxy compounds, at least one of which is a filler-containing polyether polyol,
to give an NCO-functional polyurethane prepolymer.

Examples of suitable polyisocyanates in a1) are polyisocyanates based on 1,4-butane diisocyanate, 1,5-pentane diisocyanate, 1,6-hexane diisocyanate (hexamethylene diisocyanate, HDI), 4-isocyanatomethyl-1,8-octane diisocyanate (triisocyanatononane, TIN) or cyclic systems, such as 4,4′-methylenebis(cyclohexyl isocyanate), 3,5,5-trimethyl-1-isocyanato-3-isocyanatomethyl-cyclohexane (isophorone diisocyanate, IPDI) as well as ω,ω′-diisocyanato-1,3-dimethylcyclohexane (H₆XDI).

As polyhydroxy compounds of component a2) there can be used all polyhydroxy compounds known to the person skilled in the art which preferably have a mean OH functionality of greater than or equal to 1.5, wherein at least one of the compounds contained in a2) must be a filler-containing polyether polyol.

Suitable polyhydroxy compounds which can be used in a2) are low molecular weight diols (e.g. 1,2-ethanediol, 1,3- and 1,2-propanediol, 1,4-butanediol), triols (e.g. glycerol, trimethylolpropane) and tetraols (e.g. pentaerythritol), polyether polyols, polyester polyols, polycarbonate polyols and polythioether polyols. There are preferably used in a2) as polyhydroxy compounds only substances of the above-mentioned type based on polyether.

The filler-containing polyether polyols used in a2) preferably have number-average molecular weights Mₙ of from 1000 to 20,000 g/mol, particularly preferably from 2000 to 12,000 g/mol, most particularly preferably from 3000 to 8000 g/mol. The OH functionalities of the filler-containing polyether polyols used are from ≧1.95 to ≦6.00, preferably from ≧1.95 to ≦5.00, particularly preferably from ≧1.95 to ≦4.00 and most particularly preferably 3.00.

Such polyether polyols are obtainable in a manner known per se by alkoxylation of suitable starter molecules with base catalysis or using double metal cyanide compounds (DMC compounds).

Particularly suitable polyether polyols of the component are those of the above-mentioned type having a content of unsaturated end groups of less than or equal to 0.02 milliequivalents per gram of polyol (meq/g), preferably less than or equal to 0.015 meq/g, particularly preferably less than or equal to 0.01 meq/g (determination method ASTM D2849-69).

Such polyether polyols can be prepared in a manner known per se by alkoxylation of suitable starter molecules, in particular using double metal cyanide catalysts (DMC catalysis). This is described, for example, in U.S. Pat. No. 5,158,922 (e.g. Example 30) and EP-A 0 654 302 (p. 5, 1.26 to p. 6, 1.32).

Suitable starter molecules for the preparation of polyether polyols are, for example, simple, low molecular weight polyols, water, organic polyamines having at least two N—H bonds or arbitrary mixtures of such starter molecules. Alkylene oxides suitable for the alkoxylation are in particular ethylene oxide and/or propylene oxide, which can be used in the alkoxylation in any desired sequence or also in admixture. Particular preference is given to polyethers having a propylene oxide content of 75 wt. %. Most particular preference is given to polyethers based on propylene oxide.

Preferred starter molecules for the preparation of polyether polyols by alkoxylation, in particular by the DMC process, are in particular simple polyols such as ethylene glycol, 1,2-propylene glycol and 1,4-butanediol, 1,6-hexanediol, neopentyl glycol, 2-ethyl-1,3-hexanediol, glycerol, trimethylolpropane, pentaerythritol as well as low molecular weight, hydroxyl-group-containing esters of such polyols with dicarboxylic acids of the type mentioned by way of example below, or low molecular weight ethoxylation or propoxylation products of such simple polyols, or arbitrary mixtures of such modified or unmodified alcohols.

The particular feature of the polyether polyols used is that at least one polyether polyol used contains fillers in finely dispersed form and is stable to sedimentation. Suitable fillers for these specific polyethers are, for example, organic fillers based on styrene-acrylonitrile copolymers or polyureas. The organic fillers can advantageously be produced by chemical reaction in the presence of the filler-free base polyether in that polyether. Such a reaction can be, for example, a copolymerisation of acrylonitrile with styrene in the presence of the polyether as reaction medium. A further suitable chemical reaction is the reaction of diamines and/or hydrazine with diisocyanates to give finely divided urea particles in the presence of the filler-free base polyether as reaction medium. However, the fillers can also be prepared separately and incorporated into the filler-free base polyethers in a sedimentation-stable manner using special dispersing machines with the application of high shear forces.

The preparation of the isocyanate-group-containing polyurethane prepolymers is carried out by reaction of the polyhydroxy compounds of component a2) with excess amounts of the polyisocyanates of a1). The reaction generally takes place at temperatures of from 20 to 140° C., preferably at from 40 to 120° C., optionally using catalysts known per se from polyurethane chemistry, such as, for example, tin compounds, for example dibutyltin dilaurate, or tertiary amines, for example triethylamine or diazabicyclooctane. Preference is given, however, to the reaction of a1) and a2) without the use of catalysts.

The molar ratio of the OH groups of the compounds of component a2) to the NCO groups of the polyisocyanates of a1) is preferably from 1:1.5 to 1:25, particularly preferably from 1:4 to 1:22, most particularly preferably from 1:6 to 1:18.

Additives having a stabilising action can optionally also be used before, during or after the urethanisation. Such additives can be acidic additives such as Lewis acids (electron-deficient compounds) or Bronsted acids (protonic acids) or compounds that free such acids on reaction with water.

They can also be, for example, inorganic or organic acids or also neutral compounds such as acid halides or esters, which react with water to form the corresponding acids. Particular mention may be made here of hydrochloric acid, phosphoric acid, phosphoric acid esters, benzoyl chloride, isophthalic acid dichloride, p-toluenesulfonic acid, formic acid, acetic acid, dichloroacetic acid and 2-chloropropionic acid.

The above-mentioned acidic additives can also be used to deactivate any catalysts used. In addition, they improve the stability of the urethanes prepared according to the invention, for example under thermal stress during a thin-film distillation which may be necessary or also after production on storage of the products.

The acidic additives are generally added at least in such an amount that the molar ratio of the acidic centres of the acidic additive and of the catalyst is at least 1:1. Preferably, however, an excess of the acidic additive is used, if such additives are used at all.

If acidic additives are used, they are preferably organic acids, such as carboxylic acids, or acid halides, such as benzoyl chloride or isophthalyl dichloride. Particularly preferably, no acidic additives are used.

If excess diisocyanate is to be separated off, thin-film distillation is the preferred process and is generally carried out at temperatures of from 100 to 160° C. and a pressure of from 0.01 to 3 mbar. The residual monomer content thereafter is preferably less than 1 wt. %, particularly preferably less than 0.5 wt. % (diisocyanate).

All the process steps can optionally be carried out in the presence of inert solvents. Inert solvents are to be understood as being solvents that do not react with the starting materials under the given reaction conditions. Examples are ethyl acetate, butyl acetate, methoxypropyl acetate, methyl ethyl ketone, methyl isobutyl ketone, toluene, xylene, aromatic or (cyclo)aliphatic hydrocarbon mixtures, or arbitrary mixtures of such solvents. However, the reactions according to the invention are preferably carried out without a solvent.

The addition of the components involved can be carried out in any desired sequence before, during or after the preparation of the isocyanate-group-containing prepolymers. It is, however, preferred to add the polyether polyol a2) to the polyisocyanate a1) which has been placed in a reaction vessel.

The polyisocyanate component b) is aliphatic and/or cycloaliphatic polyisocyanates based on di- or tri-isocyanates such as butane diisocyanate, pentane diisocyanate, hexane diisocyanate (hexamethylene diisocyanate, HDI), 4-isocyanatomethyl-1,8-octane diisocyanate (triisocyanato-nonane, TIN) or cyclic systems, such as 4,4′-methylenebis(cyclohexyl isocyanate), 3,5,5-trimethyl-1-isocyanato-3-isocyanatomethylcyclohexane (isophorone diisocyanate, IPDI) as well as ω,ω′-diisocyanato-1,3-dimethylcyclohexane (H₆XDI).

Polyisocyanates based on hexane diisocyanate (hexamethylene diisocyanate, HDI), 4,4′-methylenebis(cyclohexyl isocyanate) and/or 3,5,5-trimethyl-1-isocyanato-3-isocyanatomethyl-cyclohexane (isophorone diisocyanate, IPDI) are preferably used in the polyisocyanate component b). A most particularly preferred polyisocyanate is HDI.

There come into consideration as polyisocyanates for b) commercially available polyisocyanates, that is to say especially the known modification products of the above-mentioned simple diisocyanates containing urethane groups, uretdione groups, allophanate groups, biuret groups, isocyanurate groups and iminooxadiazinedione groups.

The polyisocyanates containing urethane groups include, for example, the reaction products of 1-methyl-2,4- and optionally 1-methyl-2,6-diisocyanatocyclohexane with deficient amounts of trimethylolpropane, or mixtures thereof with simple diols, such as, for example, the isomeric propane- or butane-diols. The preparation of such urethane-group-containing polyisocyanates in virtually monomer-free form is described, for example, in DE-A 1 090 196.

The polyisocyanates containing biuret groups include in particular those based on 1,6-diisocyanatohexane, the preparation of which is described, for example, in EP-A 0 003 505, DE-A 1 101 394, U.S. Pat. No. 3,358,010 or U.S. Pat. No. 3,903,127.

The polyisocyanates containing isocyanurate groups include in particular the trimers and mixed trimers of the diisocyanates mentioned by way of example above, such as, for example, the aliphatic and aliphatic-cycloaliphatic trimers and mixed trimers based on 1,6-diisocyanatohexane and/or isophorone diisocyanate, which are obtainable, for example, according to U.S. Pat. No. 4,324,879, U.S. Pat. No. 4,288,586, DE-A 3 100 262, DE-A 3 100 263, DE-A 3 033 860 or DE-A 3 144 672.

The polyisocyanates containing iminooxadiazinedione groups include in particular the trimers and mixed trimers of the diisocyanates mentioned by way of example above, such as, for example, the aliphatic trimers based on 1,6-diisocyanatohexane, which are obtainable, for example, according to EP-A 0 962 455, EP-A 0 962 454 or EP-A 0 896 009.

The (cyclo)aliphatic polyisocyanates used according to the invention generally have an isocyanate content of from 5 to 25 wt. %, a mean NCO functionality of from 2.0 to 5.0, preferably from 2.8 to 4.0, and a residual content of monomeric diisocyanates used in their preparation of less than 2 wt. %, preferably less than 0.5 wt. %. Arbitrary mixtures of the polyisocyanates mentioned by way of example can, of course, also be used.

The polyisocyanates of components a1) and b) can be identical or different. Preferably, the polyisocyanates of components a1) and b) are identical.

The polyisocyanate mixtures of a) and b) used according to the invention in A) typically have viscosities at 23° C. of from 500 to 100,000 mPas, preferably from 500 to 50,000 mPas and particularly preferably from 750 to 20,000 mPas, most particularly preferably from 1000 to 10,000 mPas.

As combination partners and reactants for the polyisocyanate mixtures A) there are used amino-functional aspartic acid esters B) of the following formula (I):

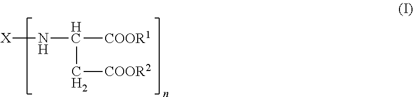

The group X in formula (I) of the polyaspartic acid esters of component B) is preferably based on an n-valent polyamine selected from the group consisting of ethylenediamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1 -amino-3 ,3 ,5-trimethyl-5-aminomethyl-cyclohexane, 2,4- and/or 2,6-hexahydrotoluylenediamine, 2,4′- and/or 4,4′-diamino-dicyclohexylmethane, 3,3′-dimethyl-4,4′-diamino-dicyclohexylmethane, 2,4,4′-triamino-5-methyl-dicyclohexylmethane, and polyether polyamines having aliphatically bonded primary amino groups with a number-average molecular weight Mₙ of from 148 to 6000 g/mol.

The group X is based particularly preferably on 1,4-diaminobutane, 1,6-diaminohexane, 2,2,4- and/or 2,4,4-trimethyl-1,6-diaminohexane, 1-amino-3,3,5-trimethyl-5-aminomethyl-cyclohexane, 4,4′-diamino-dicyclohexylmethane or 3,3′-dimethyl-4,4′-diamino-dicyclohexylmethane.

In relation to the radicals R¹ and R², “inert towards isocyanate groups under the reaction conditions” means that those radicals do not contain any groups having Zerewitinoff-active hydrogen (CH-acidic compounds; see Römpp Chemie Lexikon, Georg Thieme Verlag Stuttgart) such as OH, NH or SH.

R¹ and R², independently of one another, are preferably C₁- to C₁₀-alkyl radicals, particularly preferably methyl or ethyl radicals.

Where X is based on 2,4,4′-triamino-5-methyl-dicyclohexylmethane, preferably R¹═R²═ethyl.

n in formula (I) is preferably an integer from 2 to 6, particularly preferably from 2 to 4.

The preparation of the amino-functional polyaspartic acid esters B) is carried out in a manner known per se by reaction of the corresponding primary polyamines of the formula

X-[NH₂],ₙ

with maleic or fumaric acid esters of the general formula

R¹OOC—CH═CH—COOR²

Suitable polyamines are the diamines mentioned above as the basis for the group X.

Examples of suitable maleic or fumaric acid esters are maleic acid dimethyl ester, maleic acid diethyl ester, maleic acid dibutyl ester and the corresponding fumaric acid esters.

The preparation of the amino-functional polyaspartic acid esters B) from the mentioned starting materials is preferably carried out within the temperature range from 0 to 100° C., the starting materials being used in proportions such that at least one, preferably exactly one, olefinic double bond is present for each primary amino group, it being possible for any starting materials used in excess to be separated off by distillation following the reaction. The reaction can be carried out without a solvent or in the presence of suitable solvents such as methanol, ethanol, propanol or dioxane or mixtures of such solvents.

In the two-component coating systems according to the invention it is possible to use both individual amino-functional aspartic acid esters B) and mixtures of a plurality of amino-functional aspartic acid esters. In addition, further amino-functional compounds can be used, such as, for example, polyether polyamines having from 2 to 4, preferably from 2 to 3 and particularly preferably 2, aliphatically bonded primary amino groups and a number-average molecular weight Mₙ of from 148 to 12,200, preferably from 148 to 8200, particularly preferably from 148 to 4000 and most particularly preferably from 148 to 2000 g/mol. Further suitable amino-functional compounds as crosslinkers B) are low molecular weight aliphatic or cycloaliphatic di- and tri-amines, such as, for example, ethylenediamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3 ,3,5-trimethyl-5-aminomethyl-cyclo-hexane, 2,4- and/or 2,6-hexahydrotoluylenediamine, 2,4′- and/or 4,4′-diamino-dicyclohexylmethane, 3,3′-dimethyl-4,4′-diamino-dicyclohexylmethane, 2,4,4′-triamino-5-methyl-dicyclohexylmethane and Polyclear 136® (modified IPDA, BASF AG, Ludwigshafen) as well as optionally blocked aliphatic or cycloaliphatic polyamines, such as, for example, ketimines or aldimines, up to an amount of 50 wt. %, based on the content of aspartic acid esters in component B), used concomitantly, as a result of which the hardness and also the stiffness of the coating can be increased. There can further be used concomitantly aromatic di- and tri-amines having at least one alkyl substituent having from 1 to 3 carbon atoms on the aromatic ring, such as, for example, 2,4-toluylenediamine, 2,6-toluylenediamine, 1-methyl-3,5-diethyl-2,4-diaminobenzene, 1,3-diethyl-2,4-diaminobenzene, 1-methyl-3,5-diethyl-2,6-diaminobenzene, 1,3,5-triethyl-2,6-diaminobenzene, 3,5,3′,5′-tetraethyl-4,4′-diaminodiphenylmethane, 3,3′-dimethyl-4,4′-diaminodiphenylmethane, 1-ethyl-2,4-diaminobenzene, 1-ethyl-2,6-diaminobenzene, 2,6-diethylnaphthylene-1,5-diamine, in amounts of up to 20 wt. %, preferably up to 10 wt. % and particularly preferably up to 5 wt. %, based on the content of aspartic acid esters in component B).

The ratio of free and/or blocked amino groups to free NCO groups in the two-component coating systems according to the invention is preferably from 0.5:1 to 1.5:1, particularly preferably from 1:1 to 1.5:1.

For the production of the two-component coating systems according to the invention, the individual components are mixed together, it also being possible for typical additives, such as, for example, flow agents, dispersing agents, thickening agents, etc. as well as pigments and fillers, such as, for example, titanium dioxide, chalk, heavy spar, barium sulfate, etc., to be used concomitantly.

The mentioned coating compositions can be applied to surfaces by techniques known per se, such as spraying, dipping, flood coating, roller coating, brush coating or pouring. After any solvents present have been allowed to evaporate, the coatings then cure under ambient conditions or at higher temperatures of, for example, from 40 to 200° C.

The mentioned coating compositions can be applied, for example, to metals, plastics, ceramics, glass, concrete as well as natural materials, it being possible for the mentioned substrates previously to have been subjected to any pretreatment necessary. After curing of the coating systems according to the invention, excellent structural coatings are obtained on the substrates due to their outstanding mechanical properties.

### EXAMPLES

The determination of the NCO contents was carried out by back-titration of di-n-butylamine added in excess with hydrochloric acid. The viscosities were determined at 23° C. using a rotary viscometer (type MCR 51) from Anton Paar.

Aliphatic polyisocyanates used:

Desmodur® N 3400: Aliphatic polyisocyanate from Bayer MaterialScience AG based on hexamethylene diisocyanate having an NCO content of 21.8 wt. %.

Desmodur® N 3600: Aliphatic polyisocyanate from Bayer MaterialScience AG based on hexamethylene diisocyanate having an NCO content of 23.0 wt. %.

Filler-containing polyether polyols used:

Desmophen® 7619W: Urea-containing polyether polyol from Bayer MaterialScience AG based on propylene oxide and ethylene oxide having an OH number of 28.5 mg KOH/g and a functionality of 3.

Desmophen® 3699R: Styrene-acrylonitrile copolymer-containing polyether polyol from Bayer MaterialScience AG based on propylene oxide and ethylene oxide having an OH number of 29 mg KOH/g and a functionality of 3.

Unless indicated otherwise, all percentages are by weight.

Preparation of Polyisocyanate A1)

In a 5-litre reaction vessel, 1230 g of Desmophen® 7619W were placed under a nitrogen atmosphere and heated to 60° C. 1770 g of Desmodur® N 3400 were metered in, with stirring, in the course of 30 minutes. The reaction mixture was then stirred at 60° C. until an NCO content of about 12% was reached. The mixture was then cooled to 30° C., and the resulting product was introduced into a suitable container with nitrogen blanketing.

A non-transparent product with a milky appearance and having an NCO content of 12.1% and a viscosity of 1740 meas (23° C.) was obtained.

Preparation of Polyisocyanate A2)

The same procedure as for polyisocyanate A1) was followed, but Desmophen® 3699R was used as the polyether instead of Desmophen® 7619W.

A non-transparent product with a milky appearance and having an NCO content of 12.2% and a viscosity of 1330 mPas (23° C.) was obtained.

Preparation of Polyisocyanate A3)

The same procedure as for polyisocyanate A1) was followed, but Desmodur® N 3600 was used instead of Desmodur® N 3400 and the reaction was carried out at a temperature of 80° C.

A non-transparent product with a milky appearance and having an NCO content of 12.5% and a viscosity of 5020 mPas (23° C.) was obtained.

Preparation of Polyisocyanate A4)

The same procedure as for polyisocyanate A2) was followed, but Desmodur® N 3600 was used instead of Desmodur® N 3400 and the reaction was carried out at a temperature of 80° C.

A non-transparent product with a milky appearance and having an NCO content of 12.6% and a viscosity of 3800 mPas (23° C.) was obtained.

Preparation of Polyaspartic Acid Ester B1)

344 g (2 mol) of maleic acid diethyl ester were added dropwise at 50° C., with stirring, to 210 g (2 eq.) of 4,4′-diaminodicyclohexylmethane. When the addition was complete, the mixture was stirred for 90 hours at 60° C. under an N₂ atmosphere and dewatering was carried out for the last two hours at 1 mbar. A liquid product having an equivalent weight of 277 g was obtained.

Preparation of Polyaspartic Acid Ester B2)

344 g (2 mol) of maleic acid diethyl ester were added dropwise at 50° C., with stirring, to 238 g (2 eq.) of 3,3′-dimethyl-4,4′-diaminodicyclohexylmethane. When the addition was complete, the mixture was stirred for 90 hours at 60° C. under an N₂ atmosphere and dewatering was carried out for the last two hours at 1 mbar. A liquid product having an equivalent weight of 291 g was obtained.

Preparation of Polyaspartic Acid Ester B3)

344 g (2 mol) of maleic acid diethyl ester were added dropwise at 50° C., with stirring, to 116 g (2 eq.) of 2-methyl-1,5-pentamethylenediamine. When the addition was complete, the mixture was stirred for 90 hours at 60° C. under an N₂ atmosphere and dewatering was carried out for the last two hours at 1 mbar. A liquid product having an equivalent weight of 234 g was obtained.

Preparation of an Aliphatic Prepolymer with a Filler-Free Polyether (comparison 1)

The same procedure as for polyisocyanate A4) was followed, but 1288 g of a corresponding filler-free polyether based on propylene oxide and ethylene oxide having a functionality of 3 and an OH number of 35 mg KOH/g was used instead of Desmophen® 3699R and was reacted with 1712 g of Desmodur® N 3600 at 80° C.

A transparent product having an NCO content of 12.3% and a viscosity of 1890 mPas (23° C.) was obtained.

Preparation of an Aliphatic, Allophanate-Group-Containing Prepolymer Without Fillers (Comparison 2)

90 mg of isophthalic acid dichloride were first added to 2520.7 g of 1,6-hexane diisocyanate, and then the mixture was heated to 100° C., with stirring. There were then added, in the course of 3 hours, 1978.5 g of a polypropylene glycol which had been prepared by means of DMC catalysis (base-free) (content of unsaturated groups <0.01 meq/g, molar weight 2000 g/mol, OH number 56, theoretical functionality 2). The reaction mixture was then heated at 100° C. until an NCO content of 26.1% was reached. Then the temperature was lowered to 90° C. and, after addition of 360 mg of zinc(II) bis(2-ethylhexanoate), the reaction mixture was stirred until the NCO content was 24.3%. After addition of 360 mg of isophthalic acid dichloride, the excess 1,6-hexane diisocyanate was removed at 0.5 mbar and 140° C. by means of thin-film distillation.

A clear, colourless product having an NCO content of 5.9%, a viscosity of 2070 mPas (23° C.) and a residual content of free HDI of <0.03% was obtained.

Production of Coatings

Polyisocyanates A3) and A4) were mixed at room temperature with the amino-functional polyaspartic acid ester B3) or with mixtures of the amino-functional polyaspartic acid esters B2) and B3), an NCO/NH ratio of 1.1:1 being maintained. Corresponding films were then applied to a glass sheet using a 150 μm doctor blade. The composition and properties of the coatings are summarised in Table 1.

TABLE 1
Examples 1 to 4, Cl and C2 -
Compositions and properties of the films

| Examples | 1 | 2 | 3 | 4 | C 1 | C2 |
|---|---|---|---|---|---|---|
| Polyaspartic acid | — | — | 50.0 | 50.0 | 50.0 | 50.0 |
| ester B2 [g] | | | | | | |
| Polyaspartic acid | 100.0 | 100.0 | 50.0 | 50.0 | 50.0 | 50.0 |
| ester B3 [g] | | | | | | |
| Polyisocyanate A3) | 160.3 | | 144.9 | — | — | — |
| [g] | | | | | | |
| Polyisocyanate A4) | — | 157.9 | — | 143.6 | — | — |
| [g] | | | | | | |
| Filler-free | | | | | 147.1 | — |
| prepolymer C1 [g] | | | | | | |
| Allophanate- | | | | | — | 307.0 |
| containing | | | | | | |
| prepolymer C2 [g] | | | | | | |
| NH:NCO | 1:1.1 | 1:1.1 | 1:1.1 | 1:1.1 | 1:1.1 | 1:1.1 |
| Pot life | 20 | 21 | 20 | 22 | 24 | 23 |
| | min | min | min | min | min | min |
| Pendulum hardness: | | | | | | |
| (150 μm wet film) | | | | | | |
| after 7d | 63″ | 62″ | 70″ | 68″ | 52″ | 50″ |
| Shore D hardness: | | | | | | |
| DIN 53505 | | | | | | |
| after 7d | 53 | 53 | 59 | 57 | 45 | 41 |
| Tensile strength | | | | | | |
| ISO EN 527: | | | | | | |
| Stress at break: | 15.3 | 14.5 | 18.5 | 16.9 | 10.4 | 11.6 |
| (MPa) | | | | | | |
| St. dev. | 0.3 | 0.1 | 0.1 | 0.2 | 0.3 | 0.4 |
| Nominal stress at | 81 | 47 | 52 | 19 | 82 | 78 |
| break: (%) | | | | | | |
| St. dev. | 6.5 | 5.2 | 3.7 | 4.8 | 4.5 | 3.8 |

Polyisocyanates A3) and A4) based on filler-containing polyether, in combination with amino-functional polyaspartic acid esters, yield coating systems having an adequate pot life. The coatings have a high degree of hardness, good elongation at break and a high stress at break after drying, and are therefore particularly suitable for structural coatings. These good mechanical values cannot be achieved with corresponding filler-free polyisocyanates C1 and C2. Both the hardness and the stress at break of the filler-free coatings are lower.

1-10. (canceled)

11. A two-component coating system comprising
(A) a polyisocyanate component consisting of
a) (cyclo)aliphatic isocyanate prepolymer based on (cyclo)aliphatic polyisocyanate and at least one filler-containing polyether polyol based on styrene-acrylonitrile copolymer or polyurea,
b) (cyclo)aliphatic polyisocyanate,
(B) an amino-functional polyaspartic acid ester of the general formula (I) 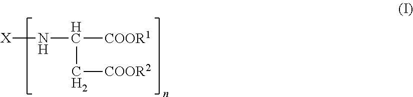
in which
X represents an n-valent organic radical, which is obtained by removing the primary amino groups of an n-valent polyamine,
R¹ and R² represent identical or different organic radicals which are inert to isocyanate groups under the reaction conditions, and
n represents an integer of at least 2,
wherein up to 50 weight % of the amino-functional polyaspartic acid ester of the general formula (I) can be replaced by amino-functional polyether, short-chained (cyclo)aliphatic diamine, optionally blocked (cyclo)aliphatic polyamines or mixtures thereof, or by aromatic di- and poly-amines, wherein the amount of aromatic di- and poly-amines is 20 weight %, based on the amount of amino-functional polyaspartic acid ester.

12. The two-component coating system according to claim 11, wherein the polyisocyanate used in (A) is prepared by reacting one or more polyhydroxy compound, wherein at least one is a polyether polyol containing finely dispersed fillers, with an excess amount of a (cyclo)aliphatic polyisocyanate b) to give an NCO-functional polyurethane prepolymer a), and a mixture of filler-containing NCO-functional polyurethane prepolymer a) and polyisocyanate component b) is then present.

13. The two-component coating system according to claim 12, wherein, in the preparation of the NCO-functional polyurethane prepolymer a) used in (A), a filler-containing polyether polyol with fillers based on copolymers of styrene and acrylonitrile is used.

14. The two-component coating system according to claim 12, wherein, in the preparation of the NCO-functional polyurethane prepolymer a) used in (A), a filler-containing polyether polyol with fillers based on urea-containing reaction products of hydrazine and toluene diisocyanate is used.

15. The two-component coating system according to claim 12, wherein, in the preparation of the polyisocyanate b) used in (A), an aliphatic polyisocyanate is used.

16. The two-component coating system according to claim 12, wherein, in the preparation of the polyisocyanate b) used in (A), a cycloaliphatic polyisocyanate is used.

17. The two-component coating system according to claim 12, wherein, in the preparation of the polyisocyanate b) used in (A), a mixture of aliphatic and cycloaliphatic polyisocyanates is used.

18. The two-component coating system according to claim 11, wherein the polyisocyanate component b) is a polyisocyanate based on hexamethylene diisocyanate.

19. A structural coating obtained from the two-component coating system according to claim 11.

20. A substrate coated with the structural coating according to claim 19.
